(19) United States
(12) Patent Application Publication
(10) Pub. No.: US 2018/0216055 A1
(43) Pub. Date: Aug. 2, 2018

(54) ALCOHOL-CONTAINING BEVERAGE WITH IMPROVED FLAVOR

(71) Applicant: SUNTORY HOLDINGS LIMITED, Osaka-shi, Osaka (JP)

(72) Inventors: Shigenao Maruyama, Miyagi (JP); Atsuki Komiya, Miyagi (JP); Noriko Nakamura, Kyoto (JP); Keisuke Matsui, Kyoto (JP)

(73) Assignee: SUNTORY HOLDINGS LIMITED, Osaka-shi, Osaka (JP)

(21) Appl. No.: 15/747,181

(22) PCT Filed: Jul. 29, 2016
(86) PCT No.: PCT/JP2016/073022

§ 371 Date: Jan. 24, 2018

(30) Foreign Application Priority Data
Jul. 29, 2015 (JP) 2015-150150

(51) Int. Cl. C12H 1/22; C12G 3/12

(52) U.S. Cl. CPC C12H 1/22; C12G 3/12

(57) ABSTRACT

To provide a method for improving the flavor of an alcohol-containing beverage. Provided are a method of leaving an alcohol-containing beverage at rest that includes leaving an alcohol-containing beverage at rest so that the liquid of the alcohol-containing beverage does not substantially move, and an alcohol-containing beverage with improved flavor that can be obtained by this method.

### TECHNICAL FIELD

The present invention relates to a method for improving the flavor of an alcohol-containing beverage and an alcohol-containing beverage obtained by this method.

### BACKGROUND ART

Conventionally, alcohol-containing beverages have been kept under an environment with little temperature change.

However, a temperature of the alcohol-containing beverage actually changes with time due to change of the seasons and daily temperature change of an external environment, and a change width of the temperature is wide.

In order to solve such a problem, in Patent Literature 1 below, a liquor storage device having a temperature regulating function, which is capable of storing liquors while regulating the temperature to be suitable for drinking is proposed. The liquor storage device in Patent Literature 1 includes, as illustrated in FIG. 1 of Patent Literature 1, a storage unit having a plurality of tanks 2, 3 and 4 that store liquors 20 respectively, a jacket 13 provided around a tank wall, a cooling device 9 that indirectly performs cooling from the tank wall by making cold air flow to the jacket 13, heating devices 18a-18c that indirectly heat each tank from the tank wall, temperature detectors 15a-15c that detect internal temperatures of the plurality of tanks 2, 3 and 4 for each tank, and a temperature regulating device 17 that controls the cooling device 9 and the heating devices 18a-18c so that a detected detection value coincides with a target value of the internal temperatures of the plurality of tanks 2, 3 and 4.

In addition, in Patent Literature 2 below, a wine aging type storage device that regulates a temperature so as to age wine is proposed. In the wine aging device in Patent Literature 2, temperature control means that controls a temperature of a wine storage compartment performs control of repeatedly raising and lowering the temperature of the wine storage compartment in accordance with a cycle preset in association with wine aging, a temperature width preset in association with wine aging, and a change pattern preset in association with wine aging.

However, while the technique described in Patent Literature 1 is to maintain the temperature inside the same tank fixed with time, since the heating devices 18a-18c are installed only on a surface where bottles are placed, it is conceivable that a spatial temperature distribution of the liquor inside the bottle is not uniform. In this case, since a Rayleigh number of a fluid in a barrel or a bottle becomes very large, natural convection is generated inside the bottle or the like, causing the movement of the fluid. In addition, generally, in feedback temperature control, there is a fluctuation around a fixed temperature to be a target. In the technique of Patent Literature 1, the liquor inside a bottle is directly affected by this temperature fluctuation, and no means for mitigating the temperature fluctuation is suggested in Patent Literature 1.

Further, in Paragraph [0077] of Patent Literature 1, it is described that “In the case of using a Peltier element, since the Peltier element serves both cooling and heating, it is not needed to use complicated apparatuses such as a refrigerator, an evaporator or a heater as before and an apparatus which generates vibration is not used so that old wine with a risk of degradation by the vibration can be stored at ease.”. However, other than the vibration from the apparatus, means for preventing the vibration is not disclosed in Patent Literature 1.

Regarding Patent Literature 2, similarly to Patent Literature 1, it is conceivable that the spatial temperature distribution of wine inside a bottle is nonuniform, but a configuration for uniformizing it is not disclosed or suggested. In addition, the technique in Patent Literature 2 positively creates the temperature width of 4° C. or more or 8° C. or more, and temporal temperature fixation control is not performed. Further, in Patent Literature 2, means for preventing vibration is not disclosed or suggested.

### CITATION LIST

### Patent literature

PTL 1: Japanese Patent Laid-Open No. 2000-274909

PTL 2: Japanese Patent No. 4109701

### SUMMARY OF INVENTION

### Technical Problem

In the prior art documents, no mention is made of an effect on changes in flavor of an alcohol-containing beverage caused by leaving the alcohol-containing beverage at rest. The present invention is implemented in consideration of this fact and an object of the present invention is to provide a method for improving the flavor of an alcohol-containing beverage by suppressing the movement of the liquid of an alcohol-containing beverage.

### Solution to Problem

(Principles of the Present Invention)

The present invention is according to the following principles. However, it is not limited thereto.

The applicant of the present application has been working for many years on a problem that why alcohol-containing beverages that are left at rest have a good flavor. In this work, the inventors of the present application conducted research on whether or not there is a relation between movement of a liquid of an alcohol-containing beverage that is left at rest and a flavor of the alcohol-containing beverage. In the process of conducting the research, the inventors of the present application paid attention to a phenomenon that a diffusion coefficient decreases in an experiment under microgravity conducted by an astronaut, and conducted an experiment of measuring a mutual diffusion coefficient of a water-ethanol based solution under the microgravity. The experiment is to preserve the water-ethanol based solution inside an experimental apparatus arranged inside an airplane in a vibration blocking state and create a microgravity state by lowering the airplane. By the experiment, a result was obtained that the mutual diffusion coefficient measured under the microgravity decreases by about 40% compared to the mutual diffusion coefficient measured when normal gravity exists in a low alcohol concentration for example. In addition, as the diffusion coefficient, there are a self-diffusion coefficient and a mutual diffusion coefficient. The self-diffusion coefficient is associated with diffusion of the movement of target molecules, and the mutual diffusion coefficient is associated with the diffusion in a solvent of a solute due to a concentration difference. In the present application, the attention is paid to the mutual diffusion coefficient.

Since the mutual diffusion coefficient changed under the microgravity even though there was no change in the component itself of a water-ethanol based solution, the experiment suggests that some change was brought to a structure of solute molecules in a solvent under the microgravity where there was no local convection in a microscopic scale. That is, in a state that chemical change does not substantially exist and there is no influence of physical change from the outside, the structure itself of solvent molecules physically changes.

The inventors of the present invention obtained the following idea from the above information.

(First Principle)

“By leaving an alcohol-containing beverage at rest for a fixed period in a state that the liquid of the alcohol-containing beverage does not move, changes in molecular association structure or the like of the alcohol-containing beverage can be further accelerated, and thereby the flavor of the alcohol-containing beverage can be improved.”

When physically changing an alcohol-containing beverage, it is usually conceivable to exert physical change from the outside, however, it is a base of the idea of the present invention that some kind of physical change of the alcohol-containing beverage itself is further accelerated by not exerting the physical change from the outside on the contrary.

An experimental result that the diffusion coefficient of the alcohol-containing beverage that is aged through a long period of time is different from the diffusion coefficient of the alcohol-containing beverage that is not aged through a long period of time has been obtained, supporting the first principle.

For example, in an experiment of measuring the diffusion coefficient using protons of ethanol by NMR, the ethanol was a target, and as an aging period became longer, the diffusion coefficient indicated a smaller value. It is conceivable that association of molecules with each other occurs around the ethanol in whisky and apparent molecular weight increases so that the movement around the ethanol becomes slow, and the diffusion coefficient becomes small as a result. That is, it is conceivable that, since there is no influence of external force, molecules (solute molecules) of the component exist in a state of an aggregate and mass transfer occurs without destroying the weak cohesion so that the diffusion coefficient appears small.

On the other hand, in an experiment of measuring the diffusion coefficient in the case of viewing the entire alcohol-containing beverage which is a multi-component system by a dynamic light scattering method (DLS), as the aging period became longer, the diffusion coefficient indicated a larger value. In one experiment, the diffusion coefficient of the whisky that was aged through a long period of time became the value of about 1.1 to 2 times of the diffusion coefficient of the whisky that was not aged through a long period of time. It is conceivable that it is a result of the fact that molecules of various sizes existed in the whisky and the molecules of low molecular weight not fixed to the association by being left at rest moved around more actively as the association around advanced. It is conceivable that, since the diffusion coefficient of the multi-component system is obtained as an integrated value of diffusion effects of individual components, even if the movement of a molecular group is little, fast mass transfer of a small particle group appears at a concentration boundary layer end as a result in a system with many small particle groups like the whisky so that the larger diffusion coefficient appears as a whole.

The first principle can be substantiated also by using the alcohol-containing beverage obtained by keeping a state that the liquid does not move by not being affected by the external physical change for a fixed period and the alcohol-containing beverage obtained by being preserved in a state that convection or the like can be generated due to the external spatial temperature change for the fixed period in a sensory evaluation test and comparing results (see a first example below). Here, “the liquid of the alcohol-containing beverage does not move” means not only that the liquid of the alcohol-containing beverage does not move at all but also that the liquid does not substantially move.

(Second Principle)

“As a method for not substantially moving the liquid of the alcohol-containing beverage based on the first principle, by maintaining at least one of temporal temperature change and spatial temperature change of the alcohol-containing beverage to be uniform, the flavor of the alcohol-containing beverage can be improved.”

By keeping the spatial temperature change of the alcohol-containing beverage uniform, the generation of the convection within the alcohol-containing beverage generated due to the spatial temperature change can be prevented, and the liquid of the alcohol-containing beverage left at rest can be substantially prevented from moving. Since the convection is not generated, the alcohol-containing beverage does not flow, and the flavor of the alcohol-containing beverage can be improved.

In addition, by keeping the temporal temperature change of the alcohol-containing beverage uniform, the movement by repetition of expansion and contraction of the liquid by the temporal temperature change can be suppressed.

Note that, regarding the temporal change of a temperature, changing the temperature of the alcohol-containing beverage very slowly within a range of a small temperature difference is also included in “uniformization of the temporal temperature change” in the present invention.

(Third Principle)

“By turning a pressure change (pressure distribution) at each height inside an alcohol-containing beverage generated due to presence of gravity to a target as the physical change from the outside in the first principle, and leaving the alcohol-containing beverage at rest in an environment of uniformizing the pressure change, that is, under zero gravity or the microgravity, the flavor of the alcohol-containing beverage can be improved.”

The zero gravity or the microgravity can be realized on a descending airplane, an artificial satellite, a spaceship, or a celestial body with very small gravity. In this case, when the alcohol-containing beverage collides with another object, the physical change (acceleration equivalent to the gravity) from the outside is imparted and the liquid of the alcohol-containing beverage moves. In order to prevent this, in the third principle, by fixing the alcohol-containing beverage under the zero gravity or the microgravity, the alcohol-containing beverage can be left at rest in the state that the pressure distribution is uniformized. When the pressure distribution becomes uniform, since the convection is not generated necessarily, an effect similar to that of the second principle can be demonstrated.

(Fourth Principle)

“By blocking at least one of the vibration, force and moment transmitted from the outside, the movement of the liquid of the alcohol-containing beverage can be suppressed, and the flavor of the alcohol-containing beverage can be efficiently improved.”

In “the vibration transmitted from the outside” in the fourth principle, the vibration transmitted by sound waves is also included other than the vibration transmitted from another object by direct contact with the device.

In “the force” in the fourth principle, all of the force or the moment brought to the article housing device is included. For example, the force and the moment generated when the device is brought into contact or collides with another object, or the force and the moment transmitted when the spaceship makes a sudden accelerating motion or rotating motion in the case that the device is connected with the spaceship are included.

The fourth principle can demonstrate further effects by being used together with the first to third principles.

For example, in the case of using the fourth principle together with the third principle, for means for attaching the article, the means for blocking the vibration from the outside or the force transmitted by contact with the outside is used. In this case, the vibration from a spaceship or a small celestial body and the force and the moment by sudden acceleration of the spaceship or a collision with another object are not transmitted to the alcohol-containing beverage, and the flavor of the alcohol-containing beverage can be improved.

(Fifth Principle)

“By shielding an external electric field, magnetic field and electromagnetic wave of a wavelength in a predetermined range, displacement of molecules of the alcohol-containing beverage left at rest can be suppressed, and thus the flavor of the alcohol-containing beverage can be efficiently improved.”

It is conceivable that an external electric field, magnetic field, or electromagnetic wave can also hinder physical changes in the alcohol-containing beverage. In the aforementioned experiment, it is conceivable that due to the growth of clusters of ethanol molecules, more active movement of smaller molecules through gaps between these clusters resulted. However, it is also conceivable that external fields could prevent the growth of clusters, and by blocking the influence of these fields, the physical change of the alcohol-containing beverage can be accelerated.

The fifth principle can be substantiated by a phenomenon that, compared to the flavor of the alcohol-containing beverage to which the electromagnetic wave of a predetermined frequency is added, contrary to the fifth principle, the flavor of the alcohol-containing beverage obtained based on the fifth principle is preferable. The flavor of the alcohol-containing beverage can be evaluated by sensory evaluation.

The fifth principle can demonstrate further effects by being used together with the first to fourth principles.

The following are aspects for realizing the first to fifth principles.

(First Aspect)

The first aspect includes, in order to realize the first principle, leaving an alcohol-containing beverage at rest so that a liquid of the alcohol-containing beverage does not substantially move.

(Second Aspect)

In the second aspect, in order to realize the second principle, the alcohol-containing beverage of the first aspect is left at rest so that at least one of spatial temperature change and temporal temperature change of the alcohol-containing beverage becomes substantially constant.

(Third Aspect)

In the third aspect, in order to realize the second principle, the alcohol-containing beverage is left at rest so that a temperature difference in at least one of the spatial temperature change and the temporal temperature change is settled in an order of 0.1 mK.

(Fourth Aspect)

In the fourth aspect, in order to realize the second principle, in the second or third aspect, at least one of the spatial temperature change and the temporal temperature change is controlled by at least one temperature control element.

(Fifth Aspect)

In the fifth aspect, in order to realize the third principle, in the first to fourth aspect, the alcohol-containing beverage is left at rest under zero gravity or microgravity.

(Sixth Aspect)

In the sixth aspect, in order to realize the fourth principle, in the first to fifth aspects, at least one of vibration, force and a moment transmitted from the outside is blocked or attenuated so that at least one of the vibration, the force and the moment is not transmitted to the alcohol-containing beverage.

(Seventh Aspect)

In the seventh aspect, in order to realize the fifth principle, in the first to sixth aspects, at least one of an electric field, a magnetic field and an electromagnetic wave of a wavelength in a predetermined range is shielded.

(Eighth Aspect)

In the eighth aspect, in order to realize the first principle, in the first to seventh aspects, a mutual diffusion coefficient of the alcohol-containing beverage left at rest is increased by a predetermined ratio or more compared to the time when the alcohol-containing beverage receives a physical change from the outside.

(Ninth Aspect)

In the ninth aspect, in order to realize the first principle, in the first to eighth aspects, the alcohol-containing beverage is left at rest for 1 day to 50 years.

(10th Aspect)

In the 10th aspect, in order to realize the first principle, in the first to ninth aspects, the alcohol-containing beverage is whisky.

(11th Aspect)

The 11th aspect is, in order to realize the first principle, intended for an alcohol-containing beverage with improved flavor that can be obtained by the first to 10th aspects.

The first to 11th aspects can be implemented, for example, by leaving an alcohol-containing beverage at rest inside a device. The device may be configured as follows:

The device includes at least one double layer formed of a heat insulator layer and a metal layer provided on an inner side of the heat insulator layer. A plurality of the, double layers may be formed;

A plurality of temperature control elements are arranged at least on a surface of the metal layer configuring the double layer on the outermost side, and the plurality of temperature control elements are controlled so that the metal layer becomes a predetermined temperature;

The heat insulator layer of the double layer on the outermost side demarcates an outermost side surface of the device;

The metal layer configuring the double layer on an innermost side demarcates an innermost side surface of the device, and an alcohol-containing beverage can be kept inside the metal layer;

A metal layer is formed further on an outer side of the heat insulator layer of the double layer and the metal layer forms an outermost side layer of the device;

A heat capacity of the device exceeds a predetermined value;

The device includes at least one metal layer, and a plurality of pipes where fluid at a fixed temperature is circulated respectively are arranged over a surface of the metal layer;

The device includes attaching means that attaches the device inside an airframe or on a celestial body under zero gravity or microgravity;

The device includes at least one double layer formed of a heat insulator layer and a metal layer provided on an inner side of the heat insulator layer. The heat insulator layer of the double layer on the outermost side may demarcate an outermost side surface of the device. Moreover, the metal layer configuring the double layer on an innermost side may demarcate an innermost side surface of the device, and an alcohol-containing beverage can be left at rest inside the metal layer;

A metal layer may be formed further on an outer side of the heat insulator layer of the double layer and the metal layer may form an outermost side layer of the device;

A heat capacity of the device is at a predetermined value;

The device may include at least one metal layer, and a plurality of pipes where fluid at a fixed temperature is circulated respectively may be arranged over a surface of the metal layer;

As vibration blocking means, a layer of an elastic material may be arranged in a vibration transmission route to the device. Here, the shielding means may be a layer of a magnetic material that covers the device so as to shield the magnetic field; and/or

The device may be configured to be installed in a storage room. This does not exclude the possibility that the device itself is configured as a storage room.

### BRIEF DESCRIPTION OF DRAWINGS

FIG. 1 is a schematic drawing of a device relating to a first embodiment of the present invention.

FIG. 2 is a schematic drawing of a device relating to a second embodiment of the present invention.

FIG. 3 is a schematic drawing of a device relating to a third embodiment of the present invention.

FIG. 4 is a schematic drawing of an example for which the second embodiment and a fifth embodiment of the present invention are combined.

FIG. 5 is a diagram illustrating change of a temperature inside a housing chamber 23a and an outside air temperature (an upper part and a lower part outside a device 2a) in 325 minutes to 2575 minutes after experiment start.

### DESCRIPTION OF EMBODIMENTS

(Alcohol-Containing Beverage)

In the present description, the alcohol-containing beverage may be a beverage that contains alcohol. The alcohol-containing beverage may be obtained through a fermentation process, may be obtained without performing the process, or may be synthetic liquor. In addition, the alcohol-containing beverage may be either unprocessed liquor or product. Here, “alcohol” in the present description means ethanol unless otherwise stated. An alcohol percentage of the alcohol-containing beverage is not limited, however, for example, a lower limit value is 0.1%, 0.5%, 0.8%, 1%, 2%, 3%, 4%, 5%, 6%, 7%, 8%, 9%, 10%, 12%, 14%, 16%, 18%, 20%, 22%, 24%, 26%, 28%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59% or 60%, and an upper limit value is 96%, 90%, 80%, 70%, 66%, 64%, 62%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31% or 30%.

The alcohol percentage of the alcohol-containing beverage can be measured using a vibration type density meter, for example. In more detail, the alcohol percentage is obtained by preparing a sample from which a carbon dioxide gas is removed by filtering or ultrasonically treating an alcohol beverage of a measurement target, then distilling the sample with direct heat, measuring a density at 15° of obtained stationary liquid, and converting it using “Table 2, Alcoholic content and density (15° C.) and specific gravity (15/15° C.) conversion table” which is an appended table of the analysis method of the National Tax Agency (2007 National Tax Agency directive No. 6, revised on Jun. 22, 2007). In addition, the alcohol percentage lower than 1.0 (v/v) % can be measured by using “B) Gas chromatography analysis method” described in the analysis method 3-4 (alcohol content) of the National Tax Agency.

Examples of the alcohol-containing beverage are whisky, brandy, wine, shochu, sake, spirits, beer, cider, plum liquor, Shaoxing wine, sherry wine, and a mixture of two or more of these, since they are beverages of appropriate alcohol percentages. Among them, distilled liquor such as whisky, brandy, shochu and spirits is preferable as the alcohol-containing beverage since it is the beverage of the appropriate alcohol percentage. Whisky is more preferable. Here, whisky is the liquor manufactured by performing saccharification, fermentation and then distillation with grains as a raw material and storing and aging the grains in wooden barrels.

The alcohol-containing beverage can be packed in containers. Any containers may be used regardless of a form or a material, and for example, aluminum cans, steel cans, bottles, plastic bottles, barrels, pouches, paper containers, flasks, beakers, various kinds of capsule type containers or various kinds of laminated containers laminated with metal foil or a plastic film or the like can be used.

(Method for Improving the Flavor of an Alcohol-Containing Beverage)

The method for improving the flavor of an alcohol-containing beverage of the present invention should include at least leaving an alcohol-containing beverage at rest so that the liquid of the alcohol-containing beverage does not substantially move. An example of thus leaving an alcohol-containing beverage at rest is to leave an alcohol-containing beverage at rest so that at least one of spatial temperature change and temporal temperature change of the alcohol-containing beverage becomes substantially constant. Here, at least one of the spatial temperature distribution and the temporal temperature distribution of the alcohol-containing beverage being substantially constant refers to the fact that the temperature difference in at least one of the spatial temperature change and the temporal temperature change is settled in an order of 0.5 mK, preferably in the order of 0.1 mK. In addition, a rest temperature can be uniformly held at 5 to 40° C. (278 to 313K) for example, preferably at 10 to 35° C. (283 to 308K), and more preferably at 15 to 30° C. (288 to 303K). Though not necessarily, for example, the rest temperature can be set to be equal to or lower than 20° C. (293K), 25° C. (298K), 26° C. (299K), 30° C. (303K) or the like. At least one of the spatial temperature change and the temporal temperature change can be controlled by the plurality of temperature control elements, for example.

A period of leaving the alcohol-containing beverage at rest can be, for example, 1 day to 50 years, preferably 5 days to 40 years, 10 days to 40 years, and 10 days to 30 years, more preferably 15 days to 30 years, 20 days to 30 years, 20 days to 20 years, and 20 days to 15 years, further preferably 25 days to 10 years, 30 days to 5 years, and 50 days to 3 years. Specifically, for example, the period can be 1 month, 2 months, 3 months, 4 months, 5 months, 6 months, 9 months, 12 months, 15 months, 18 months, 21 months, 24 months, 27 months, and 30 months.

According to the method of the present invention based on the idea of paying attention to the mutual diffusion coefficient and suppressing the movement of the liquid of an alcohol-containing beverage, physical changes of the alcohol-containing beverage itself can be accelerated, and the flavor of the alcohol-containing beverage can be efficiently improved. That is, in the case of leaving an alcohol-containing beverage at rest by the method of the present invention for the same period as in a normal method, the alcohol-containing beverage whose flavor is more improved compared to when an alcohol-containing beverage is kept by the normal method can be obtained. Then, even in the case of leaving the alcohol-containing beverage at rest in the method of the present invention for a period shorter than in the normal method, the alcohol-containing beverage having a flavor quality equivalent to the case of keeping it by the normal method can be obtained. Such a matter is especially advantageous regarding the alcohol-containing beverage for which leaving it at rest largely affects the flavor. In addition, for the alcohol-containing beverage with the improved flavor, there are also the effects that stimulation originated from alcohol becomes softer, and/or fragrance becomes very gentle and excellent or the like so that the method of the present invention is also useful for the alcohol-containing beverage in general. In this way, the flavor of the alcohol-containing beverage obtained by the method of the present invention is remarkably improved compared to the one obtained by the normal method. Here, the flavor of the alcohol-containing beverage means senses in general obtained through sensations (a sense of taste, a sense of smell, a sense of touch or the like) when drinking the alcohol-containing beverage, and examples are smoothness in the mouth and a feeling on the tongue in addition to a taste and a smell.

The present invention can be implemented, for example, according to the following aspects: However, it is not limited thereto.

### First Embodiment

The first embodiment can be implemented by leaving an alcohol-containing beverage at rest inside a device having a temperature control function.

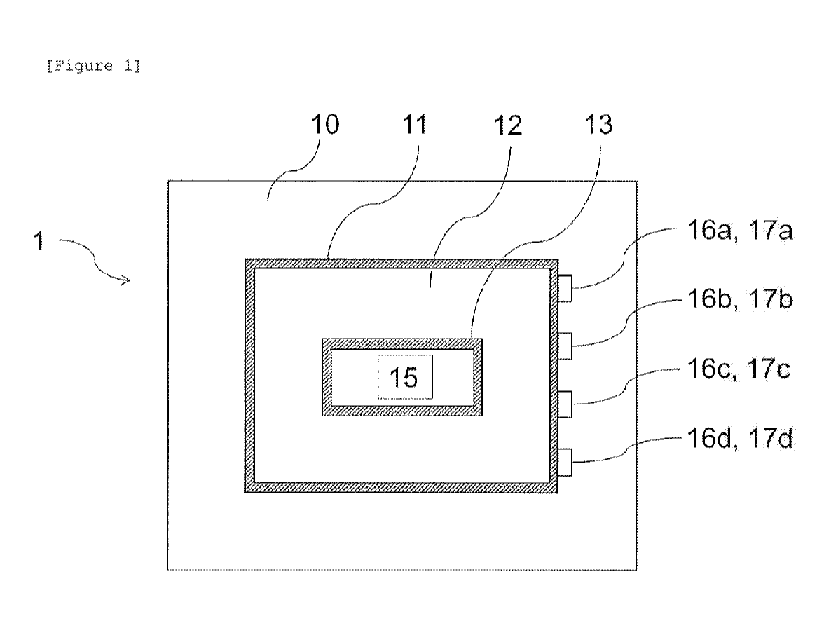

FIG. 1 illustrates a device 1 usable in the first embodiment.

The device 1 includes a first heat insulator layer 10 that demarcates an outermost side surface of the device, a first metal layer 11 arranged on an inner side of the first heat insulator layer 10, a second heat insulator layer 12 arranged on the inner side of the first metal layer 11, and a second metal layer 13 arranged on the inner side of the second heat insulator layer 12. The second metal layer 13 demarcates an innermost side surface of the device 1, and the inside of the second metal layer demarcates a housing chamber 15 where a bottle in which the alcohol-containing beverage is packed can be left at rest. Note that the metal layer may be formed by combining metal plates. In addition, the alcohol-containing beverage can be also left at rest by directly filling the alcohol-containing beverage inside the housing chamber 15.

The first and second metal layers 11 and 13 are formed in a rectangular parallelepiped or a cube for example, and are formed from a metal of high thermal conductivity such as aluminum or copper.

On one surface of the first metal layer 11, in a gravity direction from a surface upper end to a lower end, Peltier elements 16a, 16b, 16c and 16d as temperature control elements and thermistors 17a, 17b, 17c and 17d as temperature detection elements are attached. It is preferable that a distance between the Peltier elements and the thermistors is short, and it is preferable to arrange the plurality of Peltier elements and thermistors respectively so as to distribute them as equally as possible. Of course, one Peltier element and one thermistor may be arranged on one surface. Though not shown in the figure, a heat discharge device for releasing heat from the Peltier element is formed in the first heat insulator layer 10.

Note that, while the Peltier elements and the thermistors are attached on one surface of the first metal layer 11 in FIG. 1, it is needless to say that the Peltier elements and the thermistors may be also attached to other surfaces. For example, the Peltier elements and the thermistors may be attached to individual side faces other than an upper surface and a lower surface in the case of arranging the device on the ground with gravity, and the Peltier elements and the thermistors may be attached to all of the upper surface, the lower surface and the side faces in the case of arranging the device under microgravity or zero gravity.

According to the first embodiment, the Peltier elements 16a, 16b, 16c and 16d are subjected to feedback control by a controller not shown in the figure, so that temperatures detected by the respectively corresponding thermistors 17a, 17b, 17c and 17d coincide with a predetermined temperature (same target temperature). Since the first heat insulator layer 10 formed of a heat insulator of low thermal conductivity is arranged on the outer side of the first metal layer 11 where the Peltier elements are arranged, even when at least one of the temporal and spatial changes of the temperature is generated outside the device, the temperature change by heat transmitted from an external world is mitigated and transmitted to the first metal layer 11. The mitigated temperature change is immediately reduced by temperature control by the Peltier elements in the first metal layer 11 which is a good conductor of heat. Since the second heat insulator layer 12 is provided on the inner side of the first metal layer 11, the temperature change that is slightly left even after the temperature control by, the Peltier elements is further mitigated and transmitted to the second metal layer 13 on the innermost side. Since the thermal conductivity is high compared to the heat insulator, the second metal layer 13 can immediately smooth the temperature change that is finally left. Thus, in the housing chamber 15, the temporal change and spatial change of the temperature are uniformized. That is, the housing chamber 15 functions as a constant temperature chamber. Thus, convection due to a temperature difference is suppressed in the alcohol-containing beverage inside a bottle (not shown in the figure) arranged inside the housing chamber 15 or the alcohol-containing beverage directly filled inside the housing chamber 15, and flavor of the alcohol-containing beverage can be improved.

In addition, since the temperature control function is provided, the device 1 relating to the first embodiment can be configured also as a compact desktop type.

The above is the first embodiment but the present embodiment is not limited only to the above-described example. For example, while the heat insulator layer on the outer side and the metal layer on the inner side are turned to one set of a double layer and two sets of the double layers are formed in the above-described example, by providing three sets, four sets or more of the double layers, a further temperature uniformizing effect can be achieved. In this case, the outermost side layer is the heat insulator layer and the innermost side layer is the metal layer, but it is preferable that the metal layer of the innermost side layer is not provided with the temperature control function by the Peltier elements. It is because that a control temperature fluctuates around the target temperature due to the feedback control. In addition, the metal layer may be provided further on the outer side of the first heat insulator layer 10.

Also, while the Peltier elements are used as the temperature control elements and the thermistors are used as the temperature detection elements, the present invention is not limited thereto.

### Second Embodiment

While temperature fixation control of the Peltier elements or the like is positively used in the first embodiment, the second embodiment can be implemented by leaving an alcohol-containing beverage at rest inside a device not using such temperature fixation control.

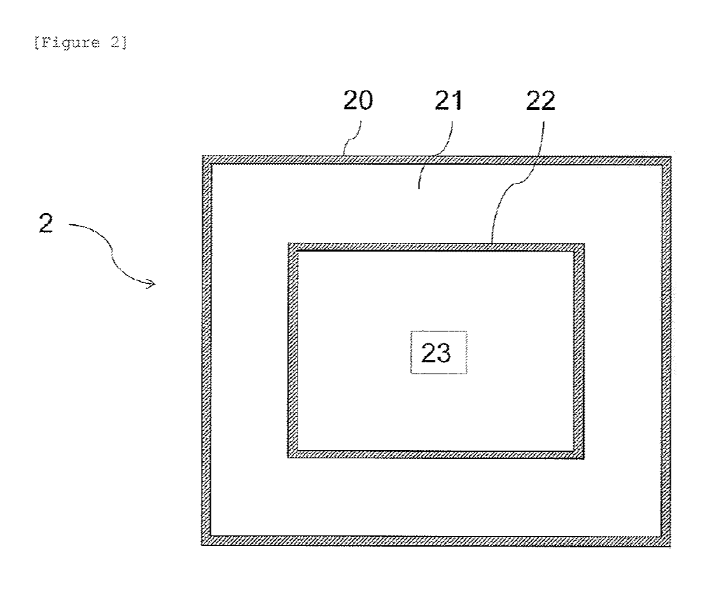

FIG. 2 illustrates a device 2 usable in the second embodiment.

The device 2 includes a first metal layer 20 that demarcates the outermost side surface of the device, a first heat insulator layer 21 arranged on the inner side of the first metal layer 20, and a second metal layer 22 that is arranged on the inner side of the first heat insulator layer 21 and demarcates the innermost side surface of the device, and the inside of the second metal layer 22 demarcates a housing chamber 23 where a bottle in which the alcohol-containing beverage is packed can be left at rest. In addition, the alcohol-containing beverage can be also left at rest by directly filling the alcohol-containing beverage inside the housing chamber 23.

According to the device 2 relating to the second embodiment, even when the spatial change of the temperature is generated outside the device, since the first metal layer 20 provided on the outermost side is the good conductor of heat, the spatial change of the temperature can be immediately reduced over the entire surface of the first metal layer 20 which is the outer side surface of the device. Since the first heat insulator layer 21 is provided on the inner side of the first metal layer 20, the temperature change that is slightly left is further mitigated and transmitted to the second metal layer 22 on the innermost side. Since the thermal conductivity is high compared to the heat insulator, the second metal layer 22 can also immediately smooth the temperature change that is finally left. Thus, in the housing chamber 23, the temporal change and spatial change of the temperature are uniformized. That is, even when there is sudden temporal temperature change, the fluctuation is absorbed by the device. Thus, convection due to a temperature difference is suppressed in the alcohol-containing beverage inside a bottle (not shown in the figure) arranged inside the housing chamber 23 or the alcohol-containing beverage directly filled inside the housing chamber 23, and the flavor of the alcohol-containing beverage can be improved.

The above is the second embodiment but the present embodiment is not limited only to the above-described example. For example, while the metal layer is provided respectively on the outer side and the inner side holding the heat insulator layer in the middle and a triple layer structure is attained in the above-described example, with the triple layer structure as one set, by providing the plurality of triple layer structures such as two sets, three sets or more, the further temperature uniformizing effect can be demonstrated.

### Third Embodiment

The third embodiment can be implemented by leaving an alcohol-containing beverage at rest inside a device of which the heat capacity is made very large in order to uniformize the temporal change of the temperature. Preferably, the device usable in the third embodiment is configured as the device including at least one metal layer. As the device relating to the third embodiment, the one of the same configuration as the devices 1 and 2 of the first and second embodiments described above may be used for instance. Of course, the third embodiment is not limited to this example.

By increasing the heat capacity of the device, even when the temperature outside the device changes with time, in the housing chamber inside the device, the temperature changes only very slowly compared to the temporal change of the external temperature. Therefore, convection is not generated in the alcohol-containing beverage inside the housing chamber, and the flavor can be improved. Here, the alcohol-containing beverage may be packed in a container such as a bottle and left at rest inside the housing chamber or may be directly filled inside the housing chamber and left at rest.

### Fourth Embodiment

The fourth embodiment can be implemented by leaving an alcohol-containing beverage at rest inside a device of an very large size. Since this device tends to generate temperature difference at each location due to its large size, the device includes means that reduces the temperature difference at each location.

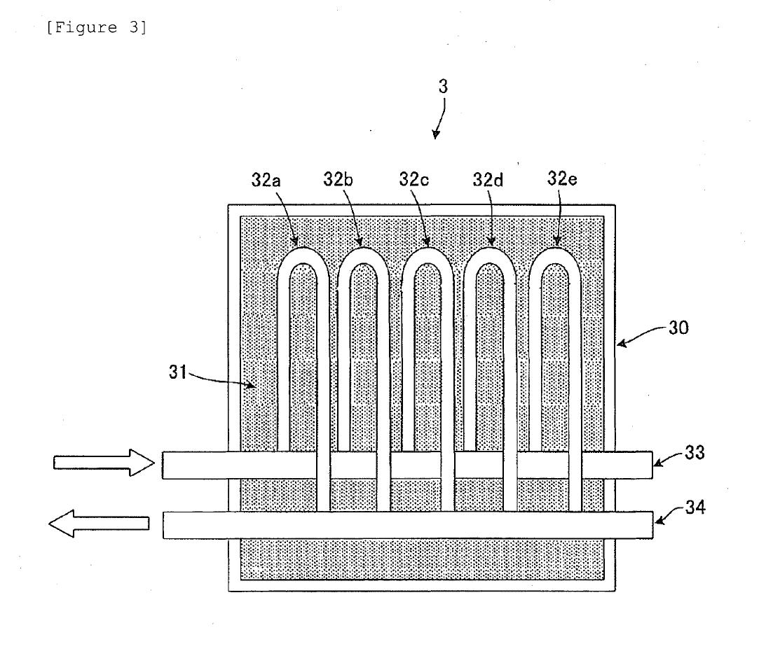

FIG. 3 illustrates a device 3 usable in the fourth embodiment.

The device 3 includes a device outer wall 30, and a device inner part 31 provided with one or more metal layers not shown in the figure. Over the surface of the metal layer (not shown in the figure) provided in the device inner part 31, a plurality of pipes 32a, 32b, 32c, 32d, 32e, . . . are arranged. A supply side pipe 33 that supplies fluid (water, for example) at a fixed temperature is connected to individual entrance ends of the pipes 32a, 32b, 32c, 32d, 32e, . . . , and a discharge side pipe 34 for discharging the fluid circulated through these pipes is connected to individual exit ends of the pipes 32a, 32b, 32c, 32d, 32e, . . . .

Note that, in the case that the device outer wall 30 is the metal layer, the pipes 32a, 32b, 32c, 32d, 32e, . . . may be arranged over the surface of the device outer wall 30. For example, in the case of using the device 2 of the configuration illustrated in FIG. 2, the pipes 32a, 32b, 32c, 32d, 32e, . . . may be arranged over the surface of at least one of the metal layers 20 and 22.

According to the fourth embodiment, even when the temperature difference at each location is generated due to the size of a large scale, the temperature difference is quickly reduced by the fluid circulated at the fixed temperature. Since the pipes 32a, 32b, 32c, 32d, 32e, . . . in the fourth embodiment are not connected to each other and only the supply side pipe 33 and the discharge side pipe 34 are in common, even when the plurality of pipes are arranged over a wide area, it is easy to maintain a fluid temperature at the fixed temperature.

Therefore, in the housing chamber inside the device, even when there is at least one of the temporal change and the spatial change of the external temperature, the temperature at each location inside the housing chamber can be kept fixed, and thus, convection is not generated in the alcohol-containing beverage inside the housing chamber, and the flavor can be improved. Here, the alcohol-containing beverage may be packed in a container such as a bottle and left at rest inside the housing chamber or may be directly filled inside the housing chamber and left at rest.

In the first to fourth embodiments described above, by uniformizing at least one of the spatial temperature change and the temporal temperature change transmitted from the outside to the housing chamber, at least one of the spatial temperature change and the temporal temperature change of the fluid of the alcohol-containing beverage is substantially uniformized (fixed at each location or at each time).

### Fifth Embodiment

The fifth embodiment can be implemented by leaving an alcohol-containing beverage at rest inside a device that is placed under an environment of the zero gravity or the microgravity.

Examples of the environment of the zero gravity or the microgravity are the inside of airframes of a space probe present in outer space, an artificial satellite orbiting around a celestial body and a falling airplane or the like. Examples of these celestial bodies are a planet such as the earth, a satellite such as the moon or the sun. Examples of the one under the microgravity are the celestial bodies of the gravity weaker than that of the earth, such as a small planet.

The device usable in the fifth embodiment includes a housing chamber for housing an alcohol-containing beverage, and attaching means for attaching the device inside the airframe or on the celestial body under the zero gravity or the microgravity. Examples of the attaching means are a metal fitting for attaching the device to an inner wall of the airframe, and an anchor for attaching the device onto the microgravity celestial body. By the attaching means, the device does not float even under the zero gravity or the microgravity, and a collision with another object can be avoided. Thus, exertion of physical change due to a collision to the housed alcohol-containing beverage can be avoided.

By using the devices of the individual embodiments described above in the fifth embodiment, an effect that the liquid of the alcohol-containing beverage is not moved can be accelerated further, however, it is not limited to these examples.

Under a zero gravity environment, convection is not generated in the alcohol-containing beverage housed inside the device, and the flavor can be improved. Here, the alcohol-containing beverage may be packed in a container such as a bottle and left at rest inside the device or may be directly filled inside the device and left at rest.

### Sixth Embodiment

The sixth embodiment can be implemented by leaving an alcohol-containing beverage at rest inside a device including vibration blocking means. The vibration blocking means can block or attenuate at least one of vibration, force and a moment transmitted from the outside of the device so that at least one of the vibration, the force and the moment is not transmitted to the alcohol-containing beverage left at rest inside the device.

In the case of arranging the device on the ground, between the device and a location (a base or a ground surface for example) where the device is placed for example, the vibration blocking means is interposed. An example of the vibration blocking means is an elastic material (rubber or a spring for example) for attenuating the vibration and force. Another aspect of the vibration blocking means is connecting means for hanging the housing chamber of the present device from a fulcrum. That is, a pendulum system in which the present device is a weight and the connecting means is a string may be configured. As the pendulum system, an inverted pendulum or a multi-stage pendulum may be used. According to the present aspect, the vibration of a frequency higher than a resonance frequency of the pendulum system can be blocked.

In addition, the vibration blocking means also includes holding the device in the air using a magnet or the like. As the vibration blocking means, sound insulating means can be also used to block the vibration by sound waves.

Further, the present device may include a detector that detects at least one of the vibration, the force (acceleration) and the moment (angular acceleration) transmitted from the outside, and the vibration blocking means may be configured as an actuator that drives the device so as to offset at least one of the detected vibration, force and moment. As the detector, an acceleration sensor or an angular acceleration sensor or the like can be used. As the actuator, a piezoelectric element or the like can be used.

The sixth embodiment can further increase the effect that the liquid of the alcohol-containing beverage is not moved by being combined with the devices of the individual embodiments described above. For example, the attaching means of the fifth embodiment can be provided with the vibration blocking means. Thus, the vibration from the airframe can be prevented from being transmitted to the device, that is, the article. In addition, the vibration blocking means (an elastic layer for example) may be put around the device usable in the fifth embodiment, and in this case, even when an object collides with the device placed in the zero gravity state, the influence of the collision can be reduced. Further, in the case that the device is attached to the airframe in the fifth embodiment, when the airframe makes a sudden accelerating motion, since the force originated from the acceleration is transmitted to the device, the device may be moved by the actuator so as to offset the acceleration detected in the acceleration sensor. In addition, possible combinations of some of the above-described modifications of the sixth embodiment can be also provided.

In the state of blocking the vibration, since the vibration is not transmitted to the alcohol-containing beverage left at rest inside the device, the flavor can be improved. Here, the alcohol-containing beverage may be packed in a container such as a bottle and left at rest inside the device or may be directly filled inside the device and left at rest.

### Seventh Embodiment

The seventh embodiment can be implemented by leaving an alcohol-containing beverage at rest inside a device that includes shielding means for shielding at least one of an electric field, a magnetic field and an electromagnetic wave of a wavelength in a predetermined range.

As the shielding means, a conductor (a metal plate or mesh) that covers the outer side of the device can be used. Thus, the propagation of the electromagnetic wave or the electric field from the outside to the inside of the device can be reduced. In the above-described embodiment in which an outer wall is already the metal conductor, it is not needed to cover the outer side further, however, it is also conceivable to cover the outer side with a metallic material of a higher shielding effect.

In addition, in the case of shielding a static magnetic field or the magnetic field of a low frequency, as the shielding means, a layer of a magnetic material that covers the outer side of the device can be used. Examples of the magnetic material are iron, permalloy, and ferrite or the like.

By using the shielding means as described above, the electric field, the magnetic field, and the electromagnetic wave of the wavelength in the predetermined range from the outside can be blocked so that displacement of molecules of the alcohol-containing beverage by these fields can be suppressed. Thus, the flavor of the alcohol-containing beverage can be efficiently improved.

The seventh embodiment can further increase the effect of not moving the alcohol-containing beverage by being combined with the devices of the individual embodiments described above, however, it is not limited to these examples.

In the state of shielding the field, since the external field is not transmitted to the molecules of the alcohol-containing beverage left at rest inside the device, the flavor can be improved. Here, the alcohol-containing beverage may be packed in a container such as a bottle and left at rest inside the device or may be directly filled inside the device and left at rest. The effect of the seventh embodiment can be substantiated by a phenomenon that the flavor of the alcohol-containing beverage obtained based on the seventh embodiment is preferable compared to the flavor of the alcohol-containing beverage obtained by exciting the molecules of the alcohol-containing beverage by the electromagnetic wave of a predetermined frequency. The flavor of the alcohol-containing beverage can be evaluated by the sensory evaluation.

The above is the embodiments of the present invention, however, the present invention is not limited to the above-described examples, and can be arbitrarily and suitably modified within the scope of the present invention.

In addition, the device usable in the present invention can be arranged at an arbitrary location. For example, in the first embodiment, since the device can be made into a small size, the device can be arranged in a living space such as in a room or on a desk. Also, by arranging the device under the ground or in a storage room with little temperature change, a further temperature uniformizing effect can be demonstrated. Furthermore, the device can be buried under the ground or the device can be enlarged to use the device itself as the storage room.

### EXAMPLES

### First Example

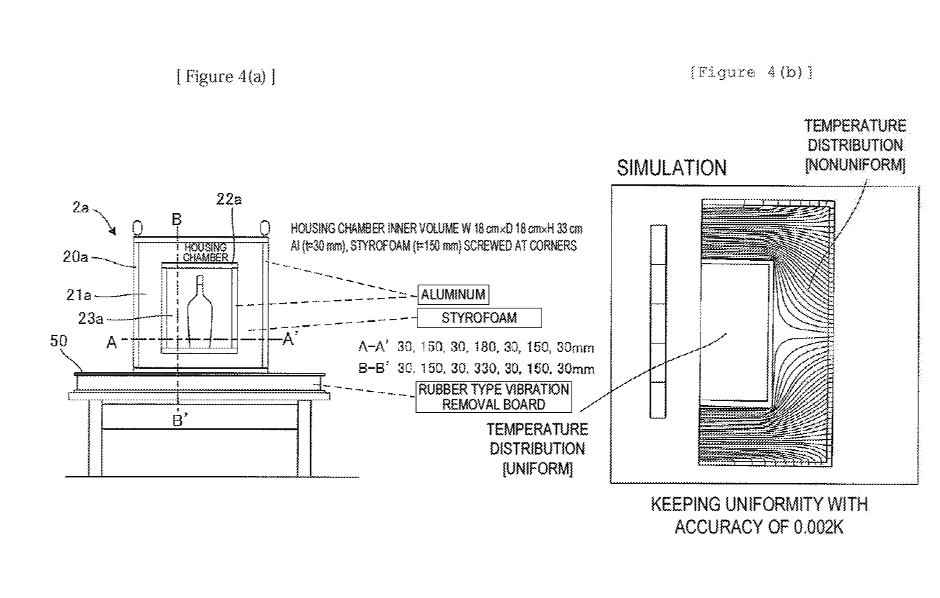

FIG. 4 illustrates a device for which the device indicated in the second embodiment and the vibration blocking means indicated in the sixth embodiment are combined.

As illustrated in FIG. 4(a), a device 2a includes a first metal layer 20a that demarcates the outermost side surface of the device, a first heat insulator layer 21a arranged on the inner side of the first metal layer 20a, and a second metal layer 22a that is arranged on the inner side of the first heat insulator layer 21a and demarcates the innermost side surface of the device. The inside of the second metal layer 22a demarcates a housing chamber 23a where a bottle 25 in which the alcohol-containing beverage is packed can be left at rest. Note that the metal layers 20a and 22a are formed of aluminum, and the first heat insulator layer 21a is formed of Styrofoam. Note that the alcohol-containing beverage may be left at rest by being directly filled in the housing chamber 23a without being packed in a container such as a bottle.

In addition, the device 2a is mounted on a desk through vibration blocking means 50 (rubber type vibration removal board).

FIG. 4(b) illustrates a simulation result of the temperature distribution inside the device 2a in FIG. 4(a). FIG. 4(b) illustrates a temperature distribution curve (isothermal line) at a predetermined interval (described in FIG. 4(a)) along an A-A′ line and a B-B′ line in FIG. 4(a). As illustrated in FIG. 4(b), it was discriminated that there is the temperature distribution in the heat insulator layer 21a but uniformity is held with accuracy of 0.002K in the housing chamber 23a.

Bottled Whisky:

Product A (Configured from unprocessed liquor for which malt whisky manufactured in Hakushu distillery is aged in barrels over 10 years. A barrel material is white oak, and the alcohol percentage is 40%), and

Unprocessed liquor B (Malt whisky manufactured in Yamazaki distillery is aged in barrels for about 18 years. The barrel material is white oak, and the alcohol percentage is 59%), was left at rest for 4 months inside the device 2a. While it was left at rest, the temperature in the housing chamber 23a was held at 26° C. (299K) (the present invention). During an experimental period, the temperature inside the housing chamber 23a and an outside air temperature (an upper part and a lower part outside the device 2a) were continuously measured. Then, as a comparative experiment 1, the bottled whisky was preserved for the same period at a normal temperature without being left at rest inside the device 2a (a conventional preservation method). Further, as a comparative experiment 2, the bottled whisky was shaken and preserved for the same period at the normal temperature without being left at rest inside the device 2a.

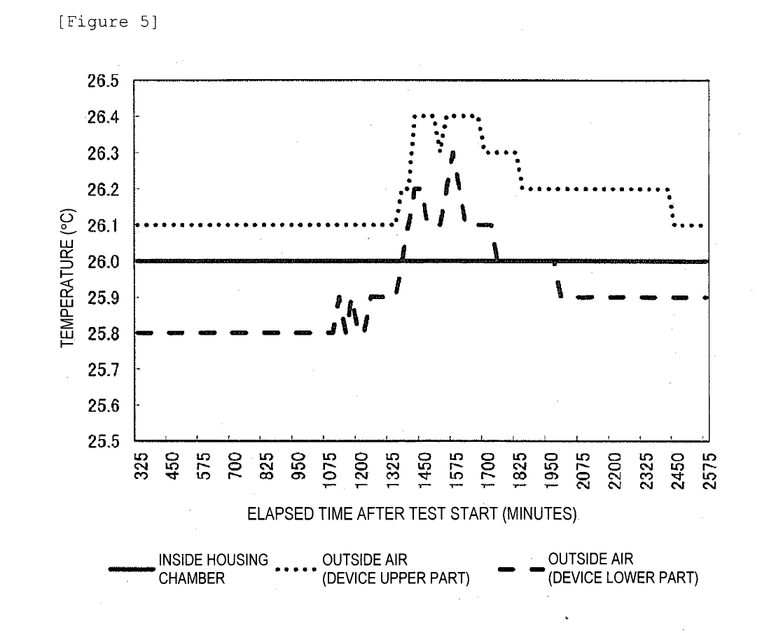

For the temperature change, the outside air temperature (the upper part and the lower part outside the device 2a) varied throughout the experiment. On the other hand, the temperature inside the housing chamber 23a was maintained fixed at a set temperature of 26° C. (299K) throughout the entire period of the experiment. As a representative example, the change of the temperature inside the housing chamber 23a and the outside air temperature (the upper part and the lower part outside the device 2a) in 325 minutes to 2575 minutes after the experiment was started is illustrated (FIG. 5). Then, the change of the temperature inside the housing chamber 23a and the outside air temperature (the upper part and the lower part of the outside device 2a) in 1300 minutes to 2500 minutes after the experiment was started, during which a difference between the temperature inside the housing chamber 23a and the outside air temperature was more clearly observed, is illustrated in Table 1.

TABLE 1
Temperature change in 1300 minutes to 2500 minutes
after experiment start

| elapsed time | inside | outside air | outside air |
|---|---|---|---|
| after test | housing | (device | (device |
| start (minutes) | chamber | upper part) | lower part) |
| 1300 | 26.0 | 26.1 | 25.9 |
| 1400 | 26.0 | 26.2 | 26.1 |
| 1500 | 26.0 | 26.4 | 26.1 |
| 1600 | 26.0 | 26.4 | 26.2 |
| 1700 | 26.0 | 26.3 | 26.1 |
| 1800 | 26.0 | 26.3 | 26.0 |
| 1900 | 26.0 | 26.2 | 26.0 |
| 2000 | 26.0 | 26.2 | 25.9 |
| 2100 | 26.0 | 26.2 | 25.9 |
| 2200 | 26.0 | 26.2 | 25.9 |
| 2300 | 26.0 | 26.2 | 25.9 |
| 2400 | 26.0 | 26.2 | 25.9 |
| 2500 | 26.0 | 26.1 | 25.9 |

From this result, it is suggested that, since the whisky obtained by the method of the present invention was left at rest at the fixed temperature of 26° C. (299K) throughout the entire period of the experiment, the liquid did not move or did not substantially move. On the other hand, it is suggested that, since the whisky obtained by the comparative experiments 1 and 2 was preserved at the normal temperature that varied significantly during the experimental period, the liquid moved due to the temperature change.

Next, the whisky (product A, unprocessed liquor B) after being left at rest or preserved was mixed with water to adjust the alcohol percentage to 20% and submitted to a sensory evaluation test. The sensory evaluation test was conducted by three skilled expert panelists under the following conditions.

### <Conditions of Sensory Test>

Three items that are the fragrance of a top note, glamorousness of the top note and softness of the taste were evaluated. Each item was evaluated out of a maximum of 5 points at 0.5 point intervals. In addition, whether or not there was a flavor characteristic was evaluated.

The evaluations of each item for the whisky preserved at the normal temperature (comparative experiment 1) was defined as 3.0, and with this as a reference, the whisky (the present invention) left at rest inside the device 2a and the whisky (comparative experiment 2) that was shaken and preserved were evaluated.

A result of the sensory evaluation test is illustrated in Table 2. Numerical values in the table indicate averages of the evaluation. The whisky of the present invention (for both of the product A and the unprocessed liquor B) was evaluated more highly than the whisky of the comparative experiment 1 for all the evaluation items. On the other hand, the whisky of the comparative experiment 2 preserved in a shaken state was evaluated lower than the whisky of the comparative experiment 1 for all the evaluation items.

TABLE 2

| | product A | | | unprocessed liquor B | | |
|---|---|---|---|---|---|---|
| | present | comparative | comparative | present | comparative | comparative |
| evaluation item | invention | experiment 1 | experiment 2 | invention | experiment 1 | experiment 2 |
| top fragrance | 4.7 | 3.0 | 1.0 | 5.0 | 3.0 | 1.0 |
| top | 4.2 | | 1.0 | 4.5 | | 1.0 |
| glamorousness | | | | | | |
| softness of | 5.0 | | 1.0 | 5.0 | | 1.0 |
| taste | | | | | | |

Further, the whisky of the present invention (for both of the product A and the unprocessed liquor B) had the following flavor characteristics compared to the whisky of the comparative experiment 1.

Stimulation originated from the alcohol felt on the tongue was weakened.

The taste was softened.

The fragrance was very gentle and excellent.

From the above, it was suggested that the movement of the liquid of the whisky while it is being left at rest greatly affects the flavor. It was suggested that, by suppressing the movement of the liquid of the whisky, the flavor is improved. It was suggested that not only the large liquid movement caused by shaking or the like but also even slight liquid movement caused by the temperature change or the like while it is being left at rest affects the flavor of the whisky.

It was indicated that, according to the method of the present invention, the liquid of the alcohol-containing beverage can be left at rest without being substantially moved, and the flavor can be improved. The flavor improving effect was remarkably high compared to the case of the preservation for the same period by the conventional method. In addition, according to the method of the present invention, it can be expected to obtain the whisky having the flavor equal to that by the conventional method in a shorter resting period.

### Second Example

An alcohol beverage was kept by the method indicated in the fifth embodiment. That is, the alcohol-containing beverage was left at rest in the environment where the convection of the liquid was suppressed by the environment of the zero gravity or the microgravity.

Inside the airframe in the outer space (under the zero gravity or the microgravity), the alcohol-containing beverages (several kinds of distilled liquor with different aging periods) sealed in glass containers were kept in the device including the housing chamber for housing the alcohol-containing beverages and the attaching means for attaching the device. The alcohol-containing beverages were kept for about one year to a plurality of years in the environment to be substantially a non-convection state and were then collected, and the alcohol-containing beverages with the improved flavor were obtained.

### REFERENCE SIGNS LIST

1, 2, 3, 2a device
10 first heat insulator layer
11 first metal layer
12 second heat insulator layer
13 second metal layer
15 housing chamber
16a, 16b, 16c, 16d Peltier element
17a, 17b, 17c, 17d thermistor
20, 20a first metal layer
21, 21a first heat insulator layer
22, 22a second metal layer
23, 23a housing chamber
50 vibration blocking means

1. A method of leaving an alcohol-containing beverage at rest, the method comprising leaving an alcohol-containing beverage at rest so that a liquid of the alcohol-containing beverage does not substantially move.

2. The method according to claim 1, wherein the alcohol-containing beverage is left at rest so that at least one of spatial temperature change and temporal temperature change of the alcohol-containing beverage becomes substantially constant.

3. The method according to claim 2, wherein the alcohol-containing beverage is left at rest so that a temperature difference in at least one of the spatial temperature change and the temporal temperature change is settled in an order of 0.1 mK.

4. The method according to claim 2, wherein at least one of the spatial temperature change and the temporal temperature change is controlled by at least one temperature control element.

5. The method according to claim 1, wherein the alcohol-containing beverage is left at rest under zero gravity or microgravity.

6. The method according to claim 1, wherein at least one of vibration, force and a moment transmitted from the outside is blocked or attenuated so that at least one of the vibration, the force and the moment is not transmitted to the alcohol-containing beverage.

7. The method according to claim 1, wherein at least one of an electric field, a magnetic field and an electromagnetic wave of a wavelength in a predetermined range is shielded.

8. The method according to claim 1, wherein a mutual diffusion coefficient of the liquid of the alcohol-containing beverage left at rest is increased by a predetermined ratio or more compared to the time when the alcohol-containing beverage is left in a state that the liquid of the alcohol-containing beverage moves.

9. The method according to claim 1, wherein the alcohol-containing beverage is left for 1 day to 50 years.

10. The method according to claim 1, wherein the alcohol-containing beverage is whisky.

11. An alcohol-containing beverage with improved flavor that can be obtained by the method according to claim 1.
